(19) United States
(12) Patent Application Publication
(10) Pub. No.: US 2001/0012453 A1
(43) Pub. Date: Aug. 9, 2001

(54) PHOTOGRAPHIC CAMERA EQUIPPED WITH MAGNETIC RECORDING HEAD

(76) Inventors: YASUHIRO NISHITANI, SAITAMA (JP); FUMIO IWAI, SAITAMA (JP); MINORU ISHIGURO, SAITAMA (JP)

Correspondence Address: YOUNG & THOMPSON, 745 SOUTH 23RD STREET 2ND FLOOR, ARLINGTON, VA, 22202

(21) Appl. No.: 09/207,422

(22) Filed: Dec. 8, 1998

(30) Foreign Application Priority Data
Dec. 9, 1997 (JP) 9-338803

(51) Int. Cl. G03B 17/24

(52) U.S. Cl. 396/319

(57) ABSTRACT

A camera for use with a filmstrip having a magnetic track along a longitudinal side of a frame thereof which is equipped with a magnetic recording head positioned at a distance from one side of the magnetic track for a frame positioned in an exposure aperture and determines, based on the distance, a length of advancement by which the filmstrip is advanced before starting data recording with the magnetic recording head and provides a data recording command to actuate the magnetic recording head to start recording the data on the magnetic track for the exposed frame when a advanced length monitoring device detects an advanced length of the filmstrip equal to the length of advancement.

### BACKGROUND OF THE INVENTION

1. Field of the Invention

The invention relates to a photographic camera for use with a filmstrip coated with a magnetic recording layer.

2. Description of Related Art

In recent years a new type of standardized photographic film and cartridge which are different from the conventional DX type of film and cartridge, have been on the market. The new type of standardized film is coated with a photosensitive layer over one surface of the base and a magnetic recording layer over another surface of the base. A camera for use with the new standardized film is designed and adapted to record data relating to an exposed frame on a specified longitudinal track defined in the magnetic recording layer for the frame during advancing the film by one frame after every exposure. The data is used, for example, to make copies of each picture and to print a date of exposure on the front or the back of the picture and/or a preselected title or caption on the back of a picture.

In this type of conventional camera, a magnetic recording head must be positioned in a specific position directly adjacent to an end of the longitudinal magnetic track for a frame positioned in an exposure aperture in order to start data recording immediately after starting advancement of the film following exposure of the frame. This layout of the magnetic recording head imposes various constraints on camera design such as a layout of interior mechanisms and parts and the overall compactness of camera.

### SUMMARY OF THE INVENTION

It is an object of the invention to provide a camera equipped with a magnetic recording head which does not impose any constraint on a location of the magnetic recording head while enabling the magnetic recording head to record data on a magnetic track from a top end thereof.

The foregoing object of the invention is accomplished by a camera for use with a filmstrip formed with magnetic tracks on lengthwise sides of frames which comprises a film advancing mechanism operative to advance a filmstrip from a film cartridge loaded in the camera after every exposure of a frame, an advanced length monitoring device operative to monitor an advanced length of the filmstrip after exposure of the frame, a magnetic recording head for recording data relating to the exposed frame on a magnetic track for the exposed frame during advancement of the filmstrip. The magnetic recording head is positioned at a distance remotely from one end of the magnetic track for a frame positioned in the exposure aperture in a direction in which the filmstrip is advanced. The camera accomplishes control for determining, based on the distance, a length of advancement by which the filmstrip is advanced before starting data recording with the magnetic recording means and providing a data recording command to actuate the magnetic recording means to start recording the data on the magnetic track for the exposed frame when the advanced length monitoring device detects an advanced length of the filmstrip equal to the length of advancement.

According to the camera of the invention, an advanced length of the filmstrip is detected during advancement of the filmstrip after every exposure and, when the advanced length of the filmstrip reaches a length of advancement, by which the filmstrip is advanced before starting data recording, based on the distance between the magnetic recording head and the end of a magnetic track, a data recording command is provided to actuate the magnetic recording head to start recording data on the magnetic track for the exposed frame. Accordingly, in the camera of the invention, data are recorded on a magnetic track starting from the top end thereof even though the magnetic recording head is positioned at a distance remotely from the magnetic track for a frame in the exposure aperture when exposure is made.

### BRIEF DESCRIPTION OF THE DRAWINGS

The above and other objects and features of the present invention will be clearly understood from the following description with respect to a preferred embodiment thereof when considered in conjunction with the accompanying drawings, wherein the same reference numerals have been used to denote same or similar parts or elements throughout the drawings and in which:

FIG. 1 is a schematic plan view of a new type of standardized filmstrip connected to a film cartridge with which a camera of the invention is used;

FIG. 2 is a schematic illustration showing a camera equipped with a magnetic recording head in accordance with an embodiment of the invention;

FIG. 3 is a perspective view of a rotary encoder installed in the camera of FIG. 1;

FIG. 4 is a view showing a layout of a magnetic recording head; and

FIG. 5 is a flow chart illustrating a camera control sequence routine for a microcomputer.

### DETAILED DESCRIPTION OF THE EMBODIMENTS

Because a camera body construction, an exposure system including a taking lens system and an aperture and shutter mechanism, a view finder system, an automatic loading mechanism and other mechanisms and parts necessary to a camera are well known in construction and operation to those skilled in the art, the following description will be directed in particular to elements forming part of, or cooperating directly with, a camera in accordance with the invention.

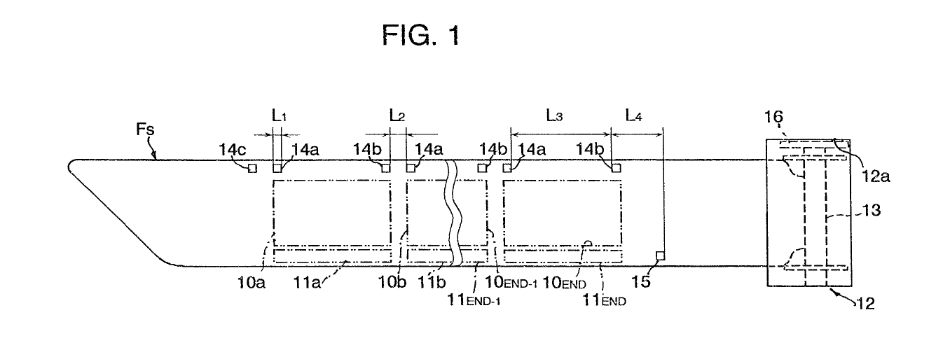

Before describing the present invention in detail, reference is made to FIG. 1 for the purpose of providing a brief description of a film that will enhance an understanding of the operation of the camera of the invention.

Referring to FIG. 1 which shows a filmstrip Fs used in the camera of the invention, the filmstrip Fs at one of its ends is secured to a film spool 13 rotatable inside a film cartridge 12 in opposite directions. The filmstrip Fs is formed with a pair of perforations, namely a front end perforation 14a and a rear end perforation 14b, which are arranged at a standardized lengthwise distance L3 adjacent one side of each frame 10n (10a, 10b, . . . and 10END). The pairs of front and rear end perforations 14a and 14b are separated at standardized regular lengthwise distances L2. The front end perforation 14a at its front edge is aligned with the front end of the frame 10n, and the rear end perforation 14b at its rear edge is aligned with the rear end of the frame 10n. The filmstrip Fs is further formed with a film front perforation 14c at the standardized lengthwise distance L2 from the foremost front end perforation 14a in the leader portion and a film end perforation 15 at a standardized lengthwise distance L4 from the rearmost rear end perforation 14b in the trailing portion. The film front perforation 14c is used to locate the filmstrip Fs in a proper position in a camera when the filmstrip Fs is loaded in the camera. The film end perforation is used to provide an indication that all available frames 10n have been exposed. These perforations 14a, 14b, 14c and 15 have a standardized lengthwise width or length L1 and are mechanically or optically detected by a perforation detecting means in the camera.

The film strip 10n is coated with a photosensitive layer over one of the entire surfaces of its base and a magnetic layer over the other entire surface. The magnetic layer is partly used as tracks 11n (11a, 11b, . . . , 11END-1 and 11END) for magnetic recording. As will be described later, information including exposure data such as shutter speeds and aperture sizes and picture information such as captions or titles, dates of exposure and print quantities are recorded on the magnetic tracks 11n adjacent to one sides of the respective frames 10n opposite to the sides where the front and rear end perforations 14a and 14b are provided.

The film spool 13 at one of its ends has an integral data disk 16 bearing bar code data on the filmstrip Fs contained in the film cartridge 12 including a film speed, a number of available frames and the type of film such as positive or negative. This data disk 16 is optically accessed through an access window 12a formed in one end wall of the film cartridge 12.

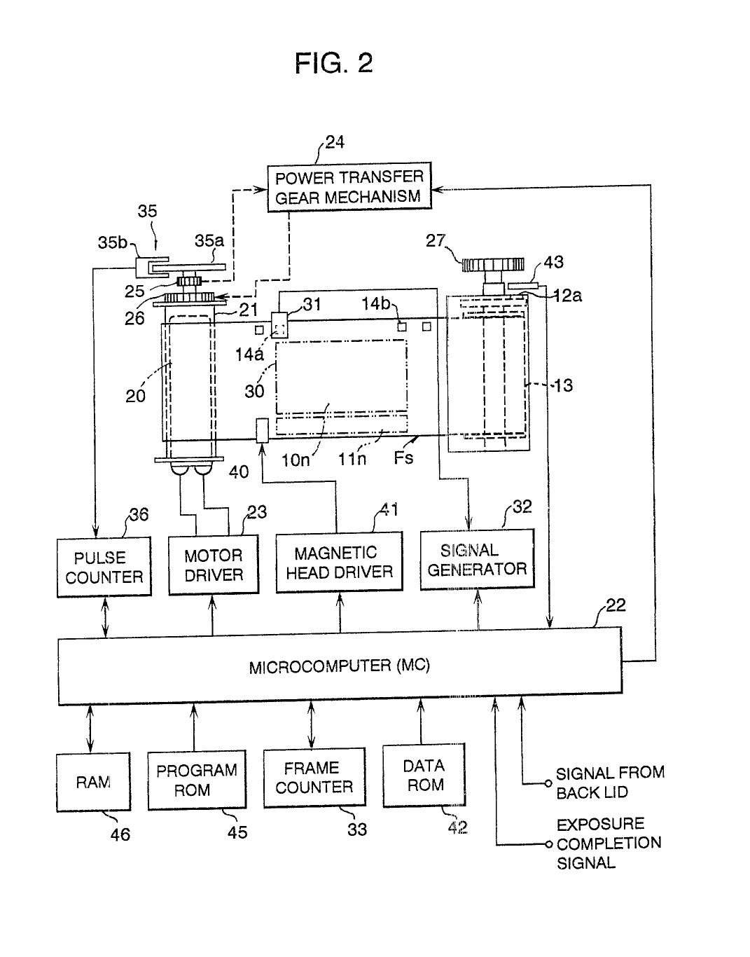

FIG. 2 schematically shows a photographic camera equipped with a magnetic recording/reproducing devices in accordance with an embodiment of the invention, which is designed and adapted for use with the filmstrip Fs shown in FIG. 1. The camera 1 has a film advancing, or winding/rewinding, mechanism comprising a film drive motor, such as a reversible motor 20, a power transfer gear mechanism 24, schematically shown with block, and gears 25, 26 and 27 which form part of the power transfer gear mechanism 24. The film drive motor 29 has a cylindrical shape and is installed in the interior of a generally cylindrically-shaped film spool 21 disposed at one side of the camera. The film drive motor 20 is controlled to rotate in two directions, namely a film winding or forward direction to wind a film 10n from the film cartridge 12 and a film rewinding or reverse direction to rewind the film 10n into the film cartridge 12. The control of the film drive motor 29 is accomplished by means of a microcomputer (MC) 22 as a camera control unit through a motor driver 23. After loading a film cartridge 12, the power transfer gear mechanism 24 is switched to a one-frame advancing mode. When the microcomputer 22 receives a signal immediately after a shutter release, the film drive motor 20 is actuated to rotate in the forward direction, and when a film rewind button (not shown) is operated, the film drive motor 20 is actuated to rotate in the reverse direction. The power transfer gear mechanism 24 is controlled by means of the microcomputer 22 to switch its power transmission path between the gears 26 and 27. Specifically, the power transfer gear mechanism 24 connects rotation of the film drive motor 20 selectively to the film spool 21 via the gears 25 and 26 to wind the filmstrip Fs onto the spool core of the film spool 12 and to the film spool 13 via the gears 25 and 27 to rewind the filmstrip Fs onto the spool core of the film spool 13. Immediately after loading a film cartridge 12, the power transfer gear mechanism 24 is switched to a film rewinding mode, and the film drive motor 20 is actuated to rotate in the reverse direction. While the film drive motor 20 rotates in the reverse direction, the bar code data on the data disk 16 are optically picked up by means of an optical sensor 43. Thereafter, the power transfer gear mechanism 24 is switched to a film advancing mode, and the film drive motor 20 is reversed to rotate in the forward direction to unwind the filmstrip Fs off the film spool 13 until the first frame 10a is positioned in an exposure aperture 30 of the camera.

The camera 1 is provided with a perforation sensor such as a reflection type of photoelectric perforation sensor 31 for detecting the perforations 14a, 14b and 14c. Various types of photoelectric sensors are known in the art, and the photoelectric perforation sensor 31 may be comprised of any well known type. This photoelectric perforation sensor 31 is of a reflection type comprised of an infrared light emission diode and a photo-transistor for receiving reflected infrared light rays. The photoelectric perforation sensor 31 is adapted to generate a photoelectric output signal in accordance with the level of infrared light received by the photo-transistor whenever it is passed by a perforation and transmits it to the signal generator 38. The photoelectric output signal is transferred to a signal generator 32 for binarization. The signal generator 32 binarizes the photoelectric output signal as a perforation signal PF. Specifically, the signal generator 32 provides a perforation signal PF at a low level when it receives a photoelectric output signal from the photoelectric perforation sensor 31 receiving light rays reflected by the photo-transistor and passed through any one of the perforations 14a, 14b and 14c or provides a perforation signal PF at a high level when it receives a photoelectric output signal from the photoelectric perforation sensor 31 receiving light rays reflected directly by the film strip 10n.

The microcomputer 22 is connected to a frame counter 33. This frame counter 33 changes its count C by an increment of 1 (one) whenever a perforation signal PF changes to the low level from the high level. The microcomputer resets the frame counter 33 to 0 (zero) when it receives a signal representing that a back lid (not shown) of the camera is closed after loading a film cartridge 12. The count C of the frame counter 33 indicates the frame number of a frame 10n in the exposure aperture 30 and is sent as frame number data to the microcomputer 22.

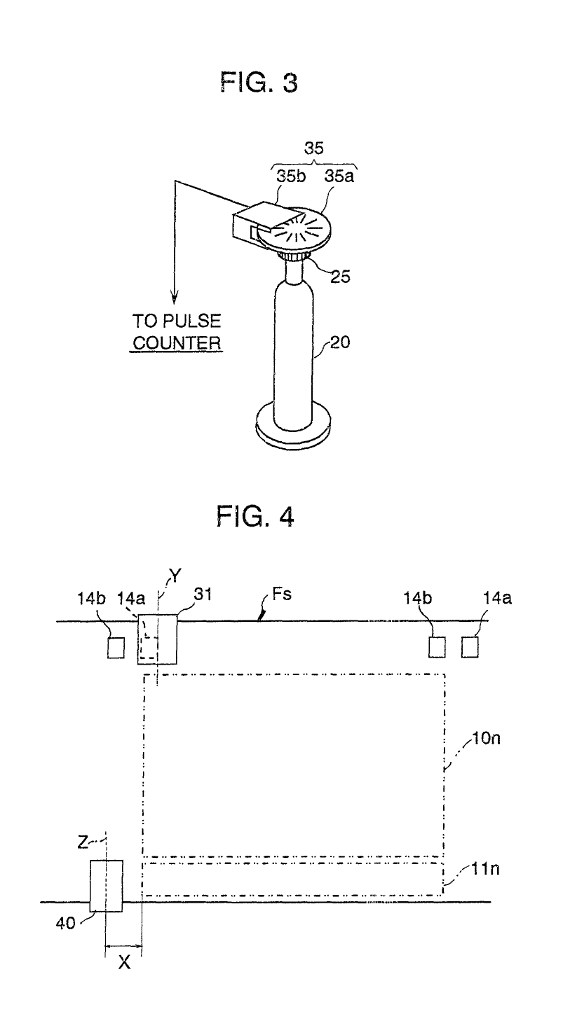

Refereeing to FIG. 3, the camera is provided with a rotary encoder 35 to avoid a change in bit rate even if the speed of advancement of the filmstrip varies. Various types of rotary encoders are known in the art, and the rotary encoder 35 may be comprised of any well known type. This rotary encoder 35 comprises an encoder disk 35a formed with a number of radial slits at regular angular intervals and capable of rotating together with the output shaft of film drive motor 20 and a photo-interrupter 35b. The photo-interrupter 35b comprises a light emitter and a light receiver between which the encoder disk 35 is interposed. The rotary encoder 35 provides an encode pulse whenever a radial slit of the rotary disk 35a passes through the photo-interrupter 35b. In other words, the rotary encoder 35 provides one encode pulse for every regular angle of rotation of the film drive motor 20. Encode pulses are counted by a pulse counter 36. The microcomputer 22 resets the count F of the pulse counter 36 to 0 (zero) immediately before commencement of film advancement and determines a length of advancement of the filmstrip Fs from the count F of the pulse counter 36.

The camera is further provided with a magnetic data recording head 40 for recording data on the magnetic track 11n. This magnetic data recording head 40 is disposed below an exposure aperture frame such that it keeps in contact with the back of the filmstrip Fs and is actuated by a magnetic head driver 41 during advancement of the filmstrip Fs to record binary coded exposure data relating to exposure of a frame including, for example, a shutter speed, an aperture size, etc., on the magnetic track 11n for the exposed frame 10n. As shown in FIG. 4, the magnetic data recording head 40 is positioned at a distance X from the front end of the magnetic track 11n for a frame in the exposure aperture 30.

Various exposure control data are stored in a data ROM 42 which, in turn, is connected to the microcomputer 22. Whenever exposure for a frame is completed, the microcomputer 22 receives binary coded exposure data corresponding to exposure data under which the frame has been exposed, from the data ROM 42 and actuates the magnetic head driver 41 according to the binary coded exposure data to drive the magnetic data recording head 40. The magnetic data recording head 40 records data on the magnetic track 11n at a constant recording rate N determined based on the count F of the pulse counter 36. In this instance, the term “recording rate” refers to a data quantity recorded per unit length of the magnetic track 11n in a direction in which the filmstrip Fs is advanced and is measured in bit/inch. The recording rate N may be varied according to total quantities of data to be recorded on the magnetic track 11n. In this case, the pulse counter 36 counts encode pulses in different manners according to recording rates.

The bar code sensor 43 is positioned in a location in which the access window 12a is located when a film cartridge 10n is loaded in the camera. Various type of bar code sensors are known in the art, and the bar code sensor 43 may be comprised of any well known type. This bar code sensor is of a reflection type photo-sensor comprised of a light emitter and a light receiver. The bar code sensor 43 projects light rays toward the data disk 16 through the access window 12a and receives light rays reflected by the data disk 16. A photoelectric signal PF, which is proportional in level to the intensity of reflected light rays, is transferred to the microcomputer 22 and decoded therein.

Camera control programs and various control parameters are stored in a program ROM 45 which, in turn, is connected to the microcomputer 30. Data necessary to execute the camera control program are temporarily stored in a RAM 46 which, in turn, is connected to the microcomputer 22. The microcomputer 22 executes various operations and control according to the control programs and parameters and further executes an operation for determining a time for commencement of data recording relative to the location of the magnetic data recording head 40. Specifically, the microcomputer 22 reads out data on the distance X between the magnetic data recording head 40 and the front end of the magnetic track 11n for a frame 10n when the frame 10n is positioned in the exposure aperture 30 and determines a length of advancement of the filmstrip Fs necessary until before the front end of the magnetic track 11n reaches the magnetic data recording head 40 after starting advancement of a frame 10n-1 subsequent to exposure of the frame 10n and data recording starts, based on the data on the distance X. The microcomputer 22 further provides the magnetic head driver 41 with a data recording start command to start data recording. Specifically, the microcomputer 22 determines the length of film advancement based on the count F of the pulse counter 36 and provides and sends a data recording start command to the magnetic head driver 41 when the necessary length of film advancement is accomplished.

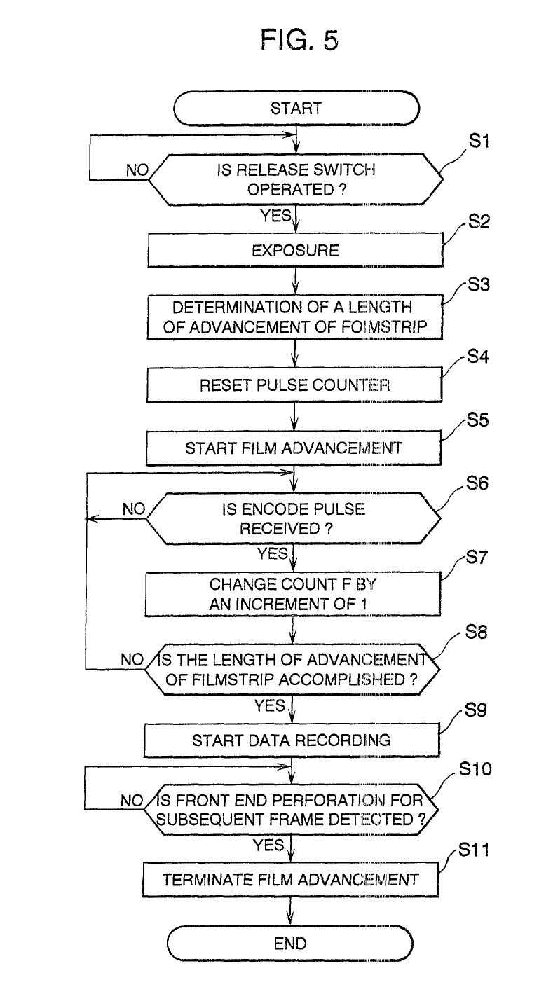

The operation depicted in FIG. 1 will be best understood by reviewing FIG. 5, which is a flow chart illustrating the camera control sequence routine for the microcomputer 22. Because programming a computer is a skill well understood in the art, the following explanation is written to enable programmers having ordinary skill in the art to furnish an appropriate program for the microcomputer 22. The particular details of such program would of course depend upon the architecture of the particular computer used.

Referring to FIG. 5, when a film cartridge 12 with a filmstrip Fs is loaded in the camera and the back lid is closed, initial setting operation is executed, before commencement of the camera control sequence routine, to reset the frame counter 33, to read bar code data on the data disk 16 of the film cartridge 12 by means of the bar code sensor 43, to decode the bar code data including the film speed, the number of available frames and the type of the filmstrip Fs by means of the microcomputer 22, to store the data in the RAM 46, and to unwind the filmstrip Fs off the film spool 13 of the film cartridge 12 until the first frame 10a is positioned in the exposure aperture 30 of the camera. The flow chart logic includes a series of camera control steps from a shutter release to positioning an unexposed frame in the exposure aperture 30 including data recording for an exposed frame. At the beginning of the series of camera control steps, the filmstrip Fs is positioned to place an unexposed frame 10n (n=a, b, . . . , END) in the exposure aperture 30 with the rear edge of front end perforation 14a for the unexposed frame 10n in alignment with the center line Y of the photoelectric perforation sensor 31 and the front end of the magnetic track 11n for the unexposed frame 10n positioned at the distance X from the center line Z of the magnetic data recording head 40. Data to be recorded on the magnetic track 10n are previously established, or otherwise selected, and stored in the RAM 46.

After accomplishing the initial setting operation of the camera, the flow chart logic commences and control proceeds directly to a decision block at step S1 where a decision is made as to whether a shutter release is made. After waiting a shutter release, a shutter (not shown) is opened for a certain time according to an exposure condition to expose the frame 10n at step S2. Subsequently, data regarding the distance X is read out from the data ROM 42 to determine a length of advancement of the filmstrip Fs necessary before commencement of data recording at step S3. After resetting the pulse counter 36 to zero (0) at step S4, a motor start command is provided to cause the motor driver 23 to actuate the film drive motor 20 to rotate in the forward direction together with switching the power transfer gear mechanism 24 to the film advancing mode at step S5, so as thereby to commence advancement of the filmstrip Fs. During the advancement of the filmstrip Fs, when the pulse counter 36 receives an encode pulse from the rotary encoder 35 at step S6, it changes its count F by an increment of 1 (one) based on which the length of advancement of the filmstrip Fs is determined at step S7. A judgement is subsequently made at step S8 as to whether the length of advancement of the filmstrip Fs is accomplished. Until the filmstrip Fs is advanced by the length of advancement, the pulse counter 36 counts pulses generated by the rotary encoder. When the filmstrip Fs has been advanced by the length of advancement, a data recording start command is provided and sent to the magnetic head driver 41 to cause the magnetic data recording head 40 to start data recording on the magnetic track 11n at step S9.

During advancement of the filmstrip Fs, the magnetic head driver 41 keeps the magnetic data recording head 40 record data on the magnetic track 11n with a recording rate N determined based on the count F. Subsequently, a judgement is made at step S10 as to whether the perforation sensor 31 detects the rear edge of the front end perforation 14b for a subsequent unexposed frame 10n+1. This judgement is made based on whether there is provided a perforation signal PF by the signal generator 32. Data recording on the magnetic track 11n is completed before the signal generator 32 provides a perforation signal PF. When perforation sensor 31 detects the rear edge of the front end perforation 14b for the subsequent unexposed frame 10n+1, the motor driver 23 stops the film drive motor 20 at step S11. After stopping the film drive motor 20, the frame counter 33 changes its count C by an increment of 1 (one). The count C is sent as data of a frame number of an unexposed frame positioned in the exposure aperture 30 to the microcomputer 22 and compared with data of the number of available frames picked up from the data disk 16 by the bar code sensor 43 and stored in the RAM 46. When the count C is greater than the number of available frames, which indicates that all available frames are exposed, then, the microcomputer 22 provides an indication that all frames are exposed, or otherwise provides the motor driver 23 with a rewind command to cause the film drive motor 20 to rotate in the reverse direction for rewinding the filmstrip Fs into the film cartridge 12. On the other hand, when the count C is less than the number of available frames, which indicates that the film strip Fs is partly exposed and partly unexposed, then, the microcomputer 22 places the camera ready for another exposure.

The perforation sensor 31 may be positioned where it detects not the rear edge of a front end perforation 14a for each frame 10n but the front edge of a front end perforation 14a for each frame 10n or either one of the front and rear edge of a rear end perforation 14b for each frame 10n. The camera may be designed in the form of what is called a pre-wind type. In the pre-wind type of camera, a filmstrip is unwound out of a film cartridge immediately alter loading the film cartridge and wound by one frame onto a film spool in the film cartridge after every exposure. In this instance, the magnetic data recording head 40 is positioned at a certain distance from the end of the magnetic track 11n close to the film cartridge between the exposure aperture and the film cartridge.

As described above, data recording on a magnetic track 11n for a frame 10n is started when a filmstrip Fs is advanced after exposure of the frame 10n by a length which is determined according to the distance X between the magnetic data recording head 40 and the front end of the magnetic track 11n for the frame 10n and detected by the rotary encoder 35. According to the camera, even if a recording rate N varying according to total quantities of data to be recorded on the magnetic track 11n, data recording is always started at the front end of each magnetic track 11n. Furthermore, the magnetic data recording head 40 is not necessary to be positioned in alignment with the front end of a magnetic track 11n for an unexposed frame 10n positioned in the exposure aperture 30 but can be positioned at a certain distance ahead of the magnetic track 11n in a direction in which the filmstrip Fs is advanced, which is always desirable for an increased degree of freedom of arrangement of parts in the interior of the camera and for miniaturizing the overall size of the camera.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

What is claimed is:

1. A camera for use with a filmstrip formed with magnetic tracks on lengthwise sides of frames, respectively, said camera comprising:
film advancing means for advancing a filmstrip out of a film cartridge loaded in the camera after every exposure of a frame;
advanced length monitoring means for monitoring an advanced length of the filmstrip by said film advancing means after exposure of said frame;
magnetic recording means for recording data relating to said frame after exposure on a magnetic track for said frame during advancement of the filmstrip, said magnetic recording means being positioned remotely at a distance from one end of a magnetic track for a frame positioned in an exposure aperture in a direction in which the filmstrip is advanced; and
control means for determining, based on said distance, a length of advancement by which the filmstrip is advanced before starting data recording with said magnetic recording means and providing a data recording command to actuate said magnetic recording means to start recording said data on said magnetic track for said frame when said advanced length monitoring means detects said advanced length of the filmstrip equal to said length of advancement.

2. The camera as defined in claim 1, wherein said magnetic recording means is positioned remotely at said distance from one end of said magnetic track for a frame in said exposure aperture remote from said cartridge.

3. The camera as defined in claim 1, wherein said camera is of a pre-wind type unwinding a filmstrip out of a film cartridge immediately alter loading a film cartridge and winding the filmstrip by one frame onto a film spool in said film cartridge after every exposure, and said magnetic recording means is positioned remotely at said distance from one end of said magnetic track for a frame positioned in said exposure aperture close to said film cartridge.

4. The camera as defined in claim 1, wherein said advanced length monitoring means comprises a rotary encoder.
